(19) United States
(12) Patent Application Publication
(10) Pub. No.: US 2026/0030406 A1
(43) Pub. Date: Jan. 29, 2026

(54) LEARNED POSED SIGNED DISTANCE FIELDS FOR PHYSICS SIMULATIONS USING A NEURAL NETWORK

(71) Applicant: Meta Platforms Technologies, LLC, Menlo Park, CA (US)

(72) Inventors: Maurizio Maria Chiaramonte, Seattle, WA (US); Joseph Davis Greer, Portland, OR (US); Kevin Thomas Carlberg, Kirkland, WA (US)

(21) Appl. No.: 17/873,052

(22) Filed: Jul. 25, 2022

(51) Int. Cl. G06F 30/20; G06F 111/18; G06T 19/20

(52) U.S. Cl. CPC G06F 30/20; G06T 19/20; G06F 2111/18; G06T 2219/2021

(57) ABSTRACT

A method processes contact in physics simulations of multi-bodies. The method includes computing a kinematic descriptor for a deformable object based on a lower dimensional description. The method also includes learning a posed signed distance field parameterized by the kinematic descriptor using a function that regresses the field. The method also includes performing contact simulation based on the posed signed distance field for the deformable object.

### TECHNICAL DATA FIELD

This application relates generally to interactive virtual environments, including, but not limited to, creating learned posed signed distance fields for real-time contact simulations in virtual reality environments.

### BACKGROUND

Contact simulations include operations that have high computational complexity. Contact simulations may be performed using triangle meshes that represent colliding objects. The complexity grows with the number of the triangle meshes (e.g., O(N) complexity for N triangles). Another technique that uses bounding volume for contact simulations is similarly expensive. Some conventional systems use model reduction and represent kinematics for an N-dimensional object using M degrees of freedom (M N). In such systems, during simulation, when objects come close, the system returns from reduced dimensionality, reconstructs outside surfaces for the objects in full dimensionality, performs collision queries, and then projects back to the lower dimensionality and updates lower dimensional coordinates. This dual conversion process is inefficient.

### SUMMARY

The embodiments herein address the problem of computational inefficiency with conventional systems that perform contact simulations. It is far more efficient to stay in the lower dimension, during contact simulation. Having a full-blown representation of the kinematics and deformed geometry encoded by the reduced dimension provides a computational advantage.

In accordance with some embodiments, a method is provided for processing contact in physics simulations of multi-bodies. The method includes computing a kinematic descriptor for a deformable object based on a lower dimensional description. The method also includes computing a posed signed distance field parameterized by the kinematic descriptor using a function that regresses the field. The method also includes performing contact simulation based on the posed signed distance field for the deformable object.

In some embodiments, computing the kinematic descriptor includes modeling (i) kinetic energy density and (ii) Helmholtz free energy density of a material, of the deformable object.

In some embodiments, the lower dimensional description is obtained using a model reduction technique.

In some embodiments, the function uses geometric regression. In some embodiments, the function uses a neural network. In some embodiments, the function uses a regressed signed distance function with a fully connected multi-layer perceptron (MLP).

In some embodiments, the kinematic descriptor is computed based on geometry codes regressed at object detection. In some embodiments, the geometry codes are learned based on (i) constructing a dataset by sampling coordinates in a continuum and evaluating deformed position for the sampled coordinates and (ii) training a fully connected network that maps the sampled coordinates and kinematic codes to a representation of a deformed configuration of the continuum.

In some embodiments, the kinematic descriptor is computed based on kinematic poses of the deformable object.

In some embodiments, the kinematic descriptor is identified by performing dimensionality reduction on data acquired from offline simulations by recording deformed states of the deformable object. Methods like Principal Component Analysis, autoencoders and similar methods, may be used to determine the reduced representation (i.e., kinematic code).

In some embodiments, the offline simulations include: (i) resolving full dynamics for the deformable object including contact, and (ii) recording snapshots of deformed geometry of the deformable object.

In some embodiments, the kinematic descriptor is used to parameterize the posed signed distance field such that the zero level-set of the posed signed distance field coincides with the deformed object's surface.

In some embodiments, the posed signed distance field is computed by fitting a model function to numerically computed signed distance function values for a set of pairs of kinematic descriptors and deformed surfaces.

Some embodiments perform simulations that resolve the full dynamics including contact and record snapshots of those simulations. With the snapshots of those simulations, some embodiments use dimensionality reduction tools, such as principal component analysis, singular value decomposition, proper orthogonal decomposition, autoencoders etc. to determine a model that maps from a low dimensional kinematic code to a full dimensional model. With the pairs of kinematic code and full dimensional deformed object representation, some embodiments train a regressor (e.g., neural network) to intake the kinematic code and a position in space and return a signed distance which may be computed to a high degree of accuracy (for training purposes) with the deformed object representation.

In accordance with some embodiments, an artificial-reality device is provided for processing contact in physics simulations of multi-bodies. The artificial-reality device includes one or more processors and memory that stores one or more programs configured for execution by the one or more processors. The one or more programs comprise instructions for performing any of the methods described herein. Artificial-reality devices may include devices capable of executing virtual-reality applications, augmented-reality applications, and/or mixed-reality applications.

In accordance with some embodiments, a non-transitory computer readable storage medium stores one or more programs configured for execution by an artificial reality device having one or more processors. The one or more programs include instructions for performing any of the methods described herein.

Thus, methods, systems, and devices are provided for creating and using learned posed signed distance fields for real-time contact simulations in virtual reality environments.

### BRIEF DESCRIPTION OF THE DRAWINGS

FIGS. 1(a)-1(d) show example visualizations for an object, using a regressed signed distance function with a fully connected multi-layer perceptron (MLP), according to some embodiments.

FIG. 2 is a schematic diagram of a decoder architecture mapping from kinematic code to a full set of discrete displacement degrees of freedom, according to some embodiments.

FIG. 3 is a schematic diagram of an architecture for mapping from kinematic code and reference position to a deformed configuration, according to some embodiments.

FIG. 4(a) is a schematic diagram of an architecture mapping geometry and kinematic code to a deformation map function, and FIG. 4(b) is schematic diagram of another architecture mapping the geometry and kinematic code to a signed distance function, according to some embodiments.

FIGS. 5A-5C show example visualizations of a contact simulation between two hands and a ball, using the techniques described herein, according to some embodiments.

FIGS. 6A-6C show another set of example visualizations of a contact simulation between two hands and a ring, using the techniques described herein, according to some embodiments.

FIG. 7 is a block diagram of a computer system, according to some embodiments.

FIG. 8 is a flowchart of a method of processing contact in physics simulations of multi-bodies, according to some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” means “when” or “upon” or “in response to determining” or “in response to detecting” or “in accordance with a determination that,” depending on the context. Similarly, the phrase “if it is determined” or “if [a stated condition or event] is detected” means “upon determining” or “in response to determining” or “upon detecting [the stated condition or event]” or “in response to detecting [the stated condition or event]” or “in accordance with a determination that [a stated condition or event] is detected,” depending on the context.

It will also be understood that, although the terms first, second, etc. are, in some instances, used herein to describe various elements, these elements should not be limited by these terms. These terms are used only to distinguish one element from another.

Some embodiments use geometric regression for learning a function ƒ_{θ}(η, x) that, given a set of weights θ, returns a signed distance field for a kinematic descriptor represented by η and a point x∈R³. An implicit surface for an object is defined by a function such that when the function is equal to zero for a point, the point lies on the surface of the object. The set of all points for which signed distance is exactly zero represent the zero level set. If the function is greater than zero for a point, the point lies outside the surface. If the function is less than zero for the point, the point lies inside the surface. When the function is equal to 0 for the point, the point lies on the surface, and this defines an implicit surface. Some embodiments train the parameters (sometimes called the weights) θ of a neural network ƒ_{θ} on a training set to make ƒ_{θ} an approximation of a given signed distance function ø in a target domain Ω (a region of space): ƒ_{θ}(η, x)≈ø(η, x), ∀x∈Ω. An example neural network is a multi-layer fully connected neural network.

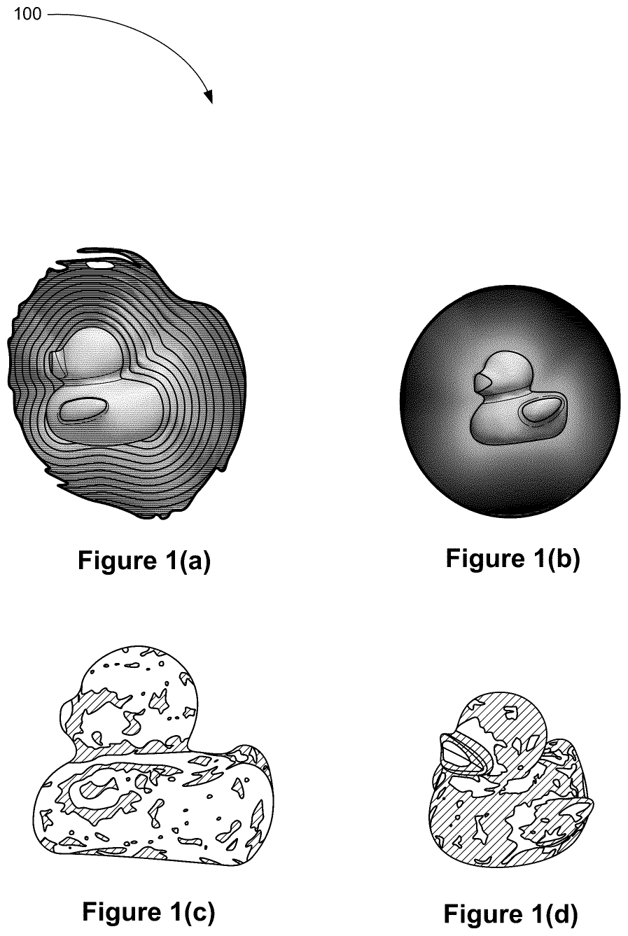

FIGS. 1(a)-1(d) show example visualizations 100 for an object, using a regressed signed distance function with a multi-layer perceptron (MLP), according to some embodiments. In this example, the object is a rubber duck. FIG. 1(a) shows contour surfaces, FIG. 1(b) shows volume contour, FIG. 1(c) shows a slice through reconstructed regions (shown in white) and true geometry (regions shown using a pattern), and FIG. 1(d) shows reconstructed regions and true geometry, for the rubber duck.

Some embodiments use a loss function

$$ℒ = {\sum }_{i = 0}^{n} ( {\sum }_{j = 0}^{m} ( \vert {f}_{θ} ( {η}_{j} , {x}_{i} ) - ∅ ( {η}_{j} , {x}_{i} ) \vert + a \vert ‖ {∇}_{x} {f}_{θ} ( {η}_{j} , {x}_{i} ) ‖ - 1 ‖ ) )$$

where the last penalization term comes from the Eikonal equation for ø: [symbol] →R in a domain [symbol] such that ∥∇ø∥=1, ∀x∈ [symbol] with relevant boundary conditions. n is number of samples in space and m is number of poses in a training dataset. ƒ_{θ} is sometimes called the learned signed distance function. The first term in the loss function above forces the learned signed distance function to match values of correct signed distance function while the second term forces the learned signed distance function to satisfy the Eikonal equation. The loss function is a quantity computed over a number of samples. There may be 1,000 samples, each sample with a corresponding position. ø(ηⱼ, xᵢ) computes exact value for a sample xᵢ for a given kinematic pose ηⱼ. θ, the weights of the function ƒ_{θ}, are learnt by minimizing the loss [symbol] with respect to θ. α is a coefficient that determines whether to sacrifice (or balance) the accuracy of the approximation of ø (in the first term) versus the value of its derivative (in the second term). The loss function may be expressed as a sum over all samples and poses, and/or may be computed using an integral.

Some embodiments use domain decomposition to reduce the complexity of the network used for regressing the signed distance function.

Some embodiments use the techniques described herein to simulate the dynamics of a deformable object. Some embodiments use these techniques to acquire a series of simulation snapshots. Suppose the domain of deformable object at a time t₀ is given by Ω₀. Let φ denote the mapping from Ω₀ to a future configuration in time, Ωₜ. Effectively φ(X, t) maps a point X∈Ω₀ to a point x∈Ωₜ. Let S denote the action of the system such that S[φ]=∫_{T}∫_{Ω}_{₀}[K(φ)−U(∇φ)]dΩ₀dt where K(V)=ρ₀∥V∥² is the kinetic energy density of the continuum, with po the density of the undeformed material, and U(F)=ψ(F) with ψ: R^{d×d}→R being the Helmholtz free energy density of material. The Helmholtz free energy density of material may be related to the object behavior. Following Hamilton's principle, the trajectory of the system is given by the stationarity of the action. A goal is to determine φ∈ [symbol] such that [symbol] δS, δφ [symbol] =ø, ∀δφ∈T [symbol] where T=[tₒ, t_{ƒ}] is a time interval, Ω₀ is the undeformed or reference domain and [symbol] ={φ∈H¹[ [symbol] ×Ω₀]|φ(t₀)=φ₀, φ(t_{ƒ})=φ_{ƒ}} and T [symbol] ={δφ∈H¹[ [symbol] ×Ω₀]|δφ(t₀)=δ_{φ}(t_{ƒ})=0}, such that

$$∀ φ , δφ ∈ TV {φ}_{ϵ} = φ + ϵδφ , \frac{d φ}{d ϵ} {\vert}_{ϵ = 0} ∈ TV .$$

There are several numerical methods for solving this problem (e.g., finite element, finite difference/volume, material point method, collocation methods). Often these methods depend on discretizing the problem in space and in time (e.g., solving for a sequence of snapshots in time of a space discrete quantity, such as values of a function at points or coefficients of linear combinations of functions).

Some embodiments construct a finite dimensional approximation of the function space [symbol] as the space spanned by basis functions

$${\{ {N}_{i} \}}_{i = 1}^{n}$$

such that

$${𝒱}^{n} = \{ {u}^{h} ∈ 𝒱 \vert {u}^{h} = {\sum }_{i = 1}^{n} {u}^{i} {N}_{i} ( X ) \} ⊂ 𝒱 ,$$

where unknowns are the uⁱ, i=1 . . . n. Some embodiments stack them in a vector U of size d×n, with

$${U}_{i \cdot d + j} = {u}_{j}^{i} .$$

Some embodiments recover [symbol] , for n→∞. So often, for accuracy reasons, n is a large number and solving for those unknowns is computationally expensive. Accordingly, some embodiments reduce dimensionality from U∈R^{d·n} to η∈R^{p} with p<<n. Some embodiments conduct representative simulations collecting a dataset [symbol] ={Uₜ}ₜ, perform principal component analysis (PCA), and project the dynamics on the principal components. This approach has several drawbacks, however. One of the drawbacks is that, for expressivity for an affine space, there has to be a fairly large number of dimensions, so this method either sacrifices accuracy or performance.

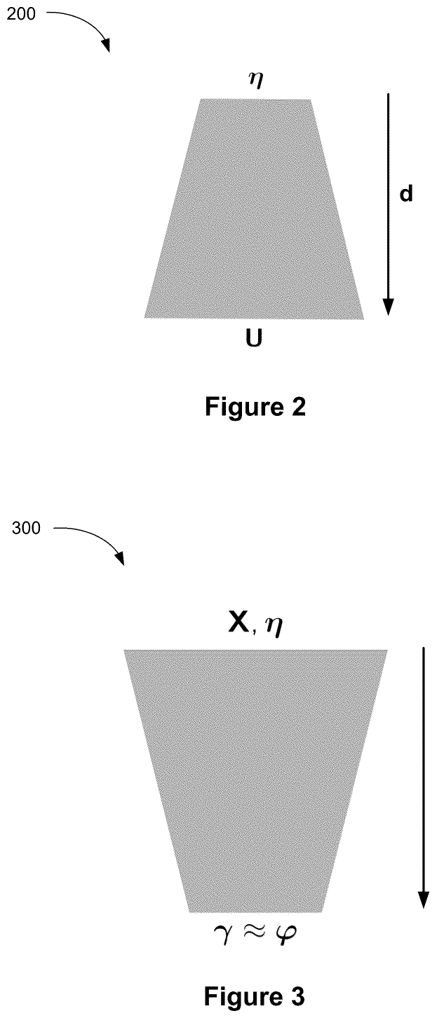

FIG. 2 is a schematic diagram of a decoder architecture 200 mapping from q, the kinematic code, to the full set of discrete displacement degrees of freedom U, according to some embodiments. Some embodiments use nonlinear embeddings for dimensionality reduction. With nonlinear embeddings, the goal is to find a mapping d: R^{p}→Rⁿ such that, as illustrated in FIG. 2, d decodes η to U such that the goal is no longer to find U(t) but rather η(t), thus dramatically reducing the number of unknowns.

Rather than discretizing and then applying compression tools, some embodiments reduce the dimensionality in the continuous setting. An objective is to find a function approximation ƒ_{θ}(η(t),X)≈φ(X, t) where η(t)∈R^{p} represents, as above, the kinematic code.

To learn ƒ_{θ}, some embodiments construct a dataset [symbol] ={{(Xᵢ,x_{i,t})}ᵢ}ₜ (i.e., for time snapshots t, sample Xᵢ∈Ω₀ and evaluate the deformed position φ(Xᵢ, t)=xᵢ). With the constructed dataset, some embodiments train a fully connected network (or other architectures) that maps the coordinates and kinematic code {η, X}∈R^{p+d} to R^{d} representing the deformed configuration of the continuum (compare to FIG. 3).

The problem thus becomes: find η∈W such that [symbol] δŜ, δη [symbol] =0,∀η∈T [symbol] , where Ŝ[η]=∫_{T} [symbol] (η)dt, [symbol] (η)=∫_{Ω}_{₀} [symbol] (η,\dot{η})dΩ₀ with [symbol] being the kinetic energy minus the potential energy. [symbol] ={η∈H¹[ [symbol] ]^{p}|η(t₀)=η₀,η(t_{ƒ})=η_{ƒ}}. Also, T [symbol] ={δη∈H¹[ [symbol] ]^{p}|δη(t₀)=δη(t_{ƒ})=0}. An advantage of this approach is that the model reduction becomes numerical method-agnostic thus allowing leverage of a variety of numerical methods to approximate the dynamics in lower dimensional manifolds.

FIG. 3 is a schematic diagram of an architecture 300 for mapping from kinematic code η and reference position X to the deformed configuration in γ(η(t), X), according to some embodiments. γ is a function that takes the kinematic code and maps all points of an undeformed object to a deformed configuration.

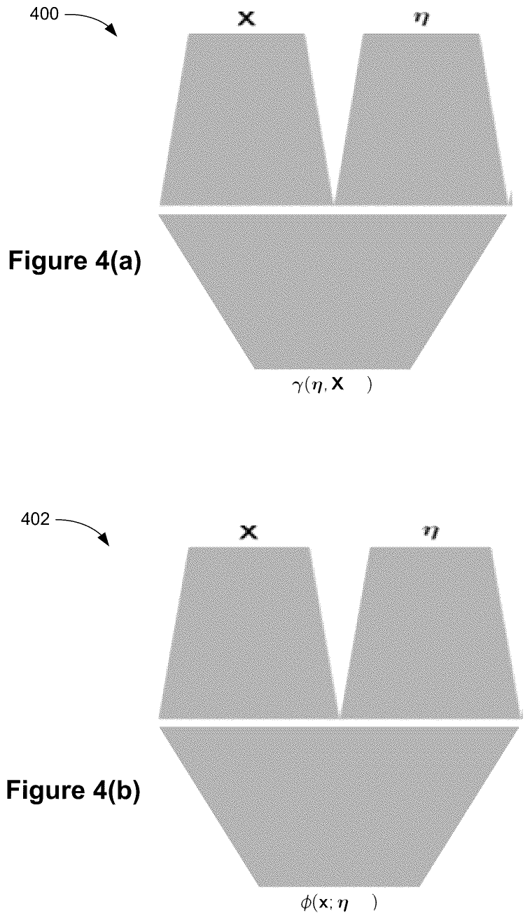

Representing objects implicitly with differentiable signed distance functions can have an enormous impact on accelerating contact simulations. Consider two soft bodies (sometimes called deformable objects) a and b. In some embodiments, a reduced kinematic map γ(η_{α}, X), α∈{a, b} (sometimes called a kinematic descriptor) is trained on both soft bodies, where η_{a,b} are the time-varying kinematic coordinates (or poses) of the two soft bodies, respectively. Further suppose ø_{α}(η_{α}, x), α∈{a, b} are the learned signed distance functions. In other words, multiple objects each may have a different signed distance function parameterized by their independent kinematic codes. FIG. 4(a) is a schematic diagram of an architecture 400 mapping kinematic code (sometimes called kinematic pose) to a deformation map function, and FIG. 4(b) is a schematic of another architecture 402 mapping the kinematic pose to a signed distance function. FIGS. 4(a) and 4(b) illustrate architectures for the function approximators. The coupling action of the two body system may be represented as \tilde{S}[ηₐ, η_{b}]=\tilde{S}[ηₐ]+\tilde{S}[η_{b}]+C[ηₐ, η_{b}] where C represents the potential due to contact. Suppose contact is enforced strongly and let [symbol] ⋅ [symbol] ₊ denote the Macaulay Bracket function. Assuming the signed distance function is negative inside,

$$C [ {η}_{a} , {η}_{b} , λ ] = {\int }_{a} λ {〈 - ∅ ( {η}_{b} , γ ( {η}_{a} , X ) ) 〉}_{+} dX + {\int }_{b} λ {〈 - ∅ ( {η}_{a} , γ ( {η}_{b} , X ) ) 〉}_{+} dX .$$

Some embodiments use only one Lagrange multiplier (X) because forces associated with the constraint are symmetric; other embodiments generalize this formulation and use two different Lagrange Multipliers. The term C penalizes penetration of the two bodies. There are at least the following advantages due to this formulation: (i) the implementation is perfectly differentiable with respect to the kinematic codes leading to a Hessian for the nonlinear solver, thus allowing quadratic convergence; and (ii) the cost associated with evaluating the signed distance is completely independent of the spatial discretization of the object and the cost is solely tied to the complexity of the model (which may be compressed using techniques, such as knowledge distillation).

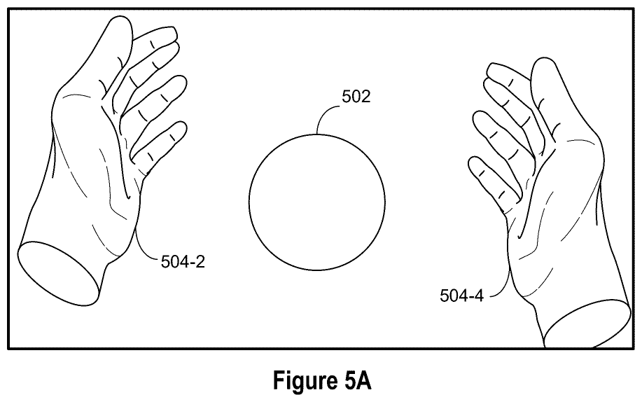

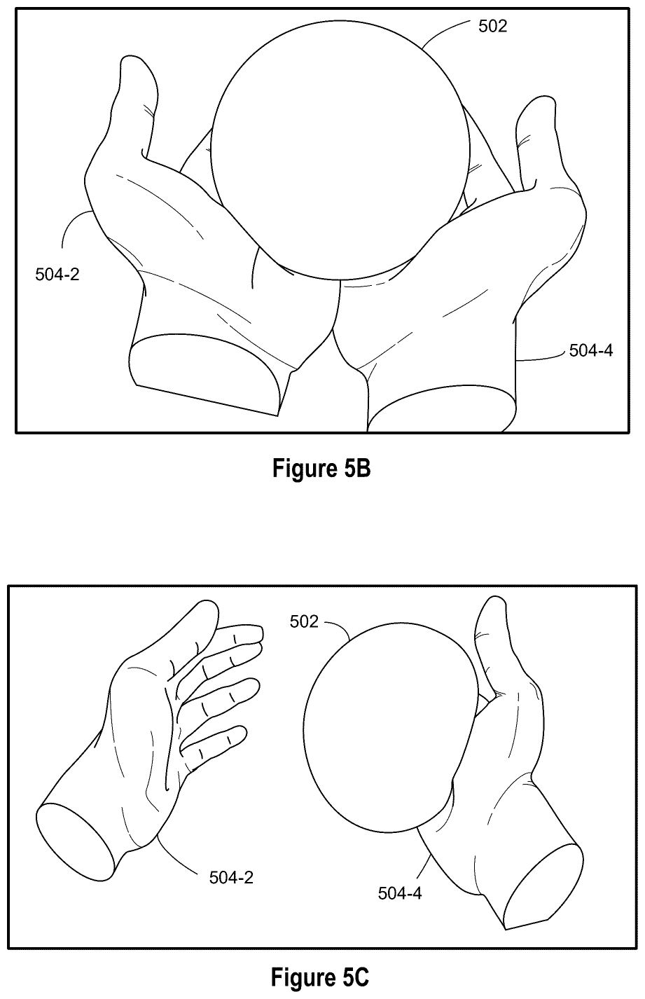

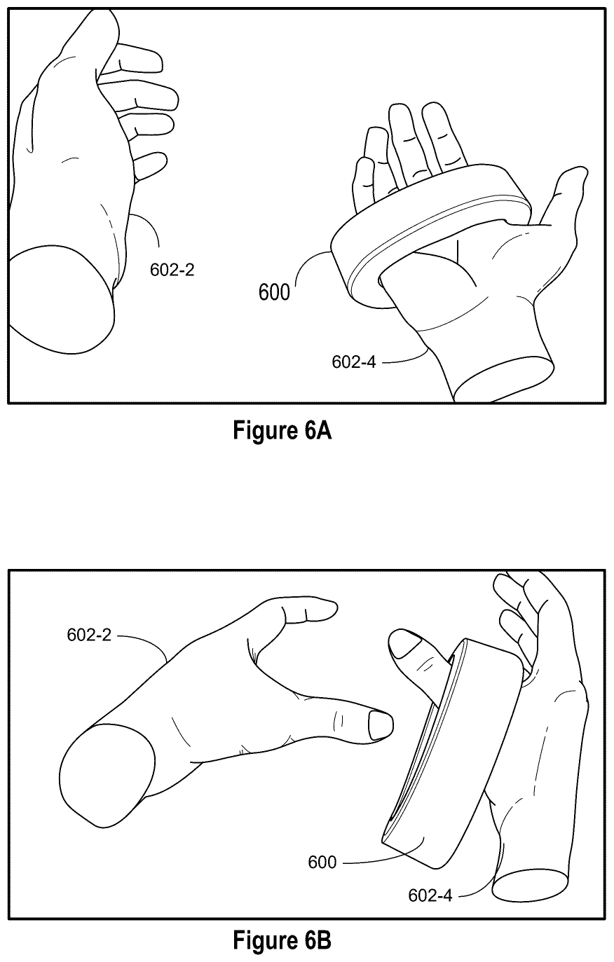

FIGS. 5A-5C show example visualizations of a contact simulation between two hands and a ball using the techniques described herein, according to some embodiments. In FIG. 5A, the two hands 504-2 and 504-4 are shown near a ball 502 (a deformable object). FIG. 5B shows the two hands holding the ball. FIG. 5C shows the ball 502 deformed when the hand 504-4 bounces the ball. Although this example shows the ball deformed, in other situations, both the hands and the ball may be deformed due to contact.

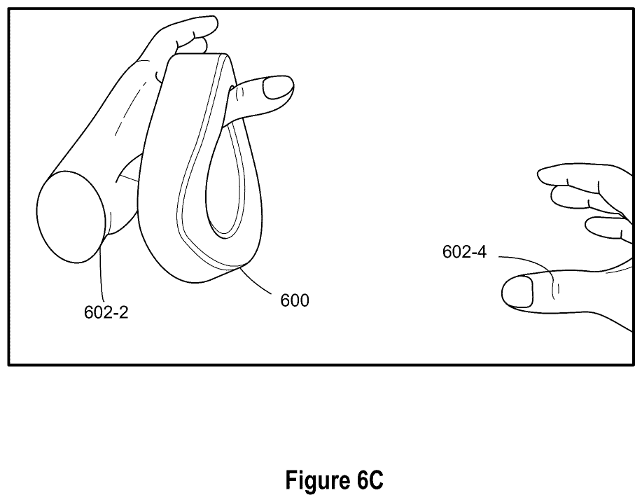

FIGS. 6A-6C show another set of example visualizations of a contact simulation between two hands and a ring, using the techniques described herein, according to some embodiments. In FIG. 6A, a hand 602-4 is shown holding a ring 600 (a deformable object). In FIG. 6B, the other hand 602-2 is shown near the ring 600 and the ring is shown hanging from a thumb of the hand 602-4. As shown in FIG. 6C, when the ring 600 is moved to the other hand 602-2 (e.g., because the other hand grabs the ring from the hand 602-4), the ring 600 changes its shape from a ring shape to a deformed shape. The deformation may be because of the movement from the one hand to the other (e.g., not just because of the contact with the other hand 602-2).

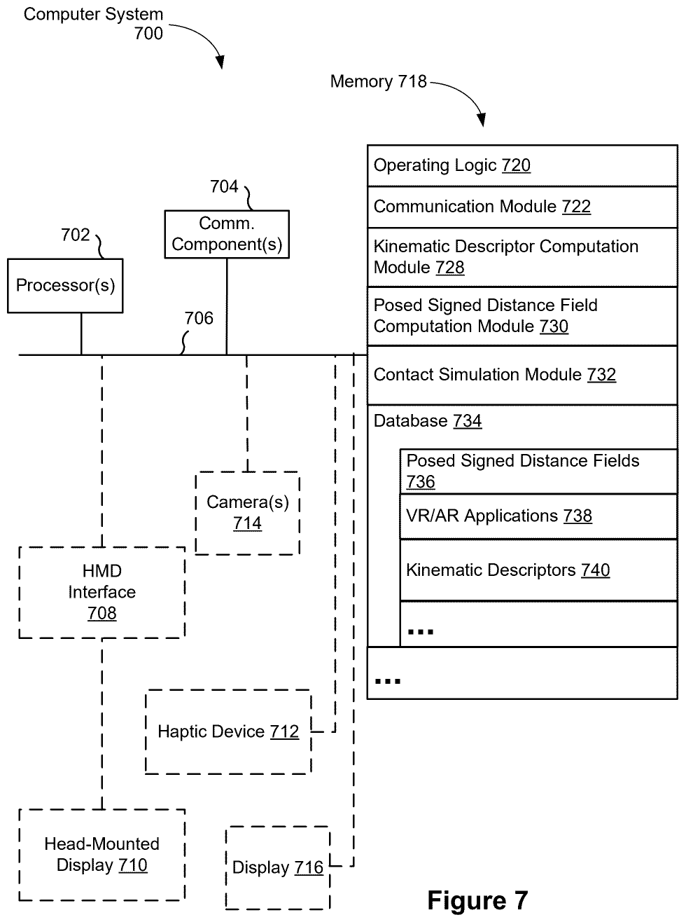

FIG. 7 is a block diagram of a computer system 700, according to some embodiments. In some embodiments, the computer system 700 is a computing device that executes applications 738 (e.g., virtual-reality applications, augmented-reality applications, and mixed-reality applications), performs contact simulations, and/or processes input data from one or more sensors on a head-mounted display 710 and/or haptic actuators on a haptic device 712. In some embodiments, the computer system 700 provides output data for (i) an electronic display on the head-mounted display 710, (ii) an audio output device (sometimes referred to herein “audio devices”) on the head-mounted display 710, and/or (iii) the haptic device 712 (e.g., processors of the haptic device 712). In some embodiments, the computer system 700 generates visualizations of the contact simulation to display on a display 716.

In some embodiments, the computer system 700 sends instructions (e.g., the output data) to the haptic device 712 using a communication interface 706. The communication interface 706 enables input and output to the computer system 700. In some embodiments, the communication interface 706 is a single communication channel, such as HDMI, USB, VGA, DVI, or DisplayPort. In other embodiments, the communication interface 706 includes several distinct communication channels operating together or independently. In some embodiments, the communication interface 706 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any other suitable communication protocol. The wireless and/or wired connections may be used for sending data collected by sensors from the head-mounted display 710 to the computer system 700. In such embodiments, the communication interface 706 also receives audio/visual data to be rendered on the display 716.

In response to receiving the instructions, the haptic device 712 may create one or more haptic stimulations (e.g., using a haptic-feedback mechanism). Alternatively, in some embodiments, the computer system 700 sends instructions to an external device, such as a wearable device, a game controller, or some other Internet of things (IoT) device, and in response to receiving the instructions, the external device creates one or more haptic stimulations through the haptic device 712 (e.g., the output data bypasses the haptic device 712). Although not shown, in the embodiments that include a distinct external device, the external device may be connected to the head-mounted display 710, the haptic device 712, and/or the computer system 700 via a wired or wireless connection.

In some embodiments, the computer system 700 sends instructions to the head-mounted display 710 using the communication interface 706 or a specialized HMD interface 708. In response to receiving the instructions, the head-mounted display 710 may present information on an electronic device. Alternatively or in addition, in response to receiving the instructions, the head-mounted display 710 may generate audio using an audio output device. In some embodiments, the instructions sent to the head-mount display 710 correspond to the instructions sent to the haptic device 712.

The computer system 700 can be implemented as any kind of computing device, such as an integrated system-on-a-chip, a microcontroller, a console, a desktop or laptop computer, a server computer, a tablet, a smart phone, or other mobile device. Thus, the computer system 700 includes components common to typical computing devices, such as a processor 702, random access memory 718, a storage device 718, a network interface 704, an input/output (I/O) interface, and the like. The processor 702 may be or include one or more microprocessors or application specific integrated circuits (ASICs). The memory may be or include RAM, ROM, DRAM, SRAM, and MRAM, and may include firmware, such as static data or fixed instructions, BIOS, system functions, configuration data, and other routines used during the operation of the computing device and the processor. The memory also provides a storage area for data and instructions associated with applications and data handled by the processor.

The storage devices provide non-volatile, bulk, or long term storage of data or instructions in the computing device. The storage devices may take the form of a magnetic or solid state disk, tape, CD, DVD, or other reasonably high capacity addressable or serial storage medium. Multiple storage devices may be provided or available to the computing device. Some of these storage devices may be external to the computing device, such as network storage or cloud-based storage. The network interface includes an interface to a network and can be implemented as either a wired or a wireless interface. The I/O interface connects the processor to peripherals (not shown) such as, for example and depending upon the computing device, sensors, displays, cameras, color sensors, microphones, keyboards, and USB devices.

In some embodiments, each application 738 is a group of instructions that, when executed by a processor, generates content for presentation to the user. An application 738 may generate content in response to contact simulation, and/or inputs received from the user via movement of the head-mounted display 710 and/or the haptic device 712. Examples of applications 738 include gaming applications, conferencing applications, and video playback applications.

In some embodiments, the haptic stimulations created by the haptic device 712 can correspond to data presented (either visually or auditory) by the head-mounted display 710 (e.g., an avatar touching the user's avatar) and/or contact simulations. Thus, the haptic device 712 is used to further immerse the user in virtual- and/or augmented-reality experience such that the user not only sees (at least in some instances) the data on the head-mounted display 710, but the user may also “feel” certain aspects of the displayed data.

In some embodiments, the computer system 700 includes one or more processing units 702 (e.g., CPUs, microprocessors, and the like), a communication interface 706, memory 718, and one or more communication buses 706 for interconnecting these components (sometimes called a chipset). In some embodiments, the computer system 700 includes cameras 714 and/or camera interfaces to communicate with external cameras, internal and/or external audio devices for audio responses.

In some embodiments, the memory 718 in the computer system 700 includes high-speed random access memory, such as DRAM, SRAM, DDR SRAM, or other random access solid state memory devices. In some embodiments, the memory includes non-volatile memory, such as one or more magnetic disk storage devices, one or more optical disk storage devices, one or more flash memory devices, or one or more other non-volatile solid state storage devices. The memory, or alternatively the non-volatile memory within memory, includes a non-transitory computer-readable storage medium. In some embodiments, the memory, or the non-transitory computer-readable storage medium of the memory, stores the following programs, modules, and data structures, or a subset or superset thereof.
operating logic 720, including procedures for handling various basic system services and for performing hardware dependent tasks;
a communication module 722, which couples to and/or communicates with remote devices (e.g., the haptic device 712, any audio devices, the head-mounted display 710, and/or other wearable devices) in conjunction with the communication interface 706;
a kinematic descriptor computation module 728, which computes kinematic descriptors 740;
a posed signed distance field computation module 728, which computes posed signed distance fields 736 based on the kinematic descriptors 740;
a contact simulation module 732, which performs contact simulations using the posed signed distance fields 736 (e.g., contact simulations that simulate user interactions with a virtual environment, examples of which are described above in reference to FIGS. 5A-5C and 6A-6C); and
a database 734, which stores:
   the posed signed distance fields 736;
   the VR/AR applications 738, which may use the contact simulations, and/or haptic feedback, and/or audio feedback generated by the computer system 700; and
   the kinematic descriptors 740.

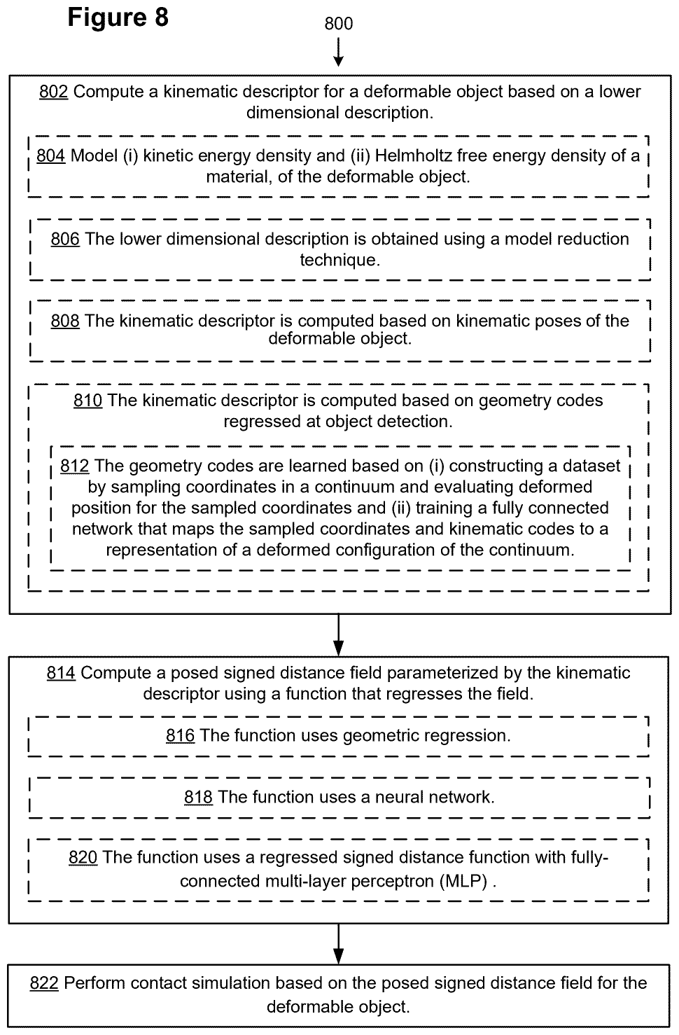

Details of the kinematic descriptor computation module 728, the kinematic descriptor computation module 728, and the contact simulation module 732 are further described below in reference to FIG. 8, according to some embodiments.

FIG. 8 is a flowchart of a method 800 of processing contact in physics simulations of multi-bodies, according to some embodiments. The method may be performed by one or more modules of the computing device 700.

The method includes computing (802) (e.g., by the kinematic descriptor computation module 728) a kinematic descriptor 740 for a deformable object based on a lower dimensional description. Examples of the deformable object include the soft bodies a and b in the description above in reference to FIG. 4, the ball in the description above in reference to FIGS. 5A-5C, and the ring in the description above in reference to the FIGS. 6A-6C. An example of the kinematic descriptor is the reduced kinematic map γ described above. In some embodiments, computing the kinematic descriptor includes modeling (804) (i) kinetic energy density and (ii) Helmholtz free energy density of a material, of the deformable object. In some embodiments, the lower dimensional description is obtained (806) using a model reduction technique. In some embodiments, the kinematic descriptor is computed (808) based on kinematic poses (e.g., the time-varying kinematic coordinates η_{a,b}) of the deformable object.

The method also includes computing (814) (e.g., using the posed signed distance field computation module 730) a posed signed distance field (e.g., the posed signed distance field 736; ø(ηₐ, γ(η_{b}, X))) parameterized by the kinematic descriptor using a function that regresses the field. In some embodiments, the function uses (816) geometric regression. In some embodiments, the function uses (818) a neural network. In some embodiments, the function uses (820) a regressed signed distance function with a fully connected multi-layer perceptron (MLP).

The method also includes performing (822) (e.g., by the contact simulation module 732) contact simulation based on the posed signed distance field for the deformable object. In some embodiments, the contact simulation may be performed for (and/or during the course of performing) the VR/AR applications 738.

Thus, in various embodiments, systems and methods are described for creating and using learned posed signed distance fields for real-time contact simulations in virtual reality environments.

Although some of various drawings illustrate a number of logical stages in a particular order, stages, which are not order dependent, may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the precise forms disclosed. Many modifications and variations are possible in view of the above teachings. The embodiments were chosen and described in order to best explain the main principles and practical applications, to thereby enable others skilled in the art to best utilize the various embodiments and make various modifications as are suited to the particular use contemplated.

What is claimed is:

1. A method of processing contact in physics simulations of multi-bodies, the method comprising:
computing a kinematic descriptor for a deformable object based on a lower dimensional description;
computing a posed signed distance field parameterized by the kinematic descriptor using a function that regresses the field; and
performing contact simulation based on the posed signed distance field for the deformable object.

2. The method of claim 1, wherein computing the kinematic descriptor comprises modeling (i) kinetic energy density and (ii) Helmholtz free energy density of a material, of the deformable object.

3. The method of claim 1, wherein the lower dimensional description is obtained using a model reduction technique.

4. The method of claim 1, wherein the kinematic descriptor is identified by performing dimensionality reduction on data acquired from offline simulations by recording deformed states of the deformable object.

5. The method of claim 4, wherein the offline simulations comprise (i) resolving full dynamics for the deformable object including contact, and (ii) recording snapshots of deformed geometry of the deformable object.

6. The method of claim 1, wherein the kinematic descriptor is used to parameterize the posed signed distance field such that zero level-set of the posed signed distance field coincides with the deformable object's surface.

7. The method of claim 1, wherein the posed signed distance field is computed by fitting a model function to numerically computed signed distance function values for a set of pairs of kinematic descriptors and deformed surfaces.

8. The method of claim 1, wherein the function uses a neural network.

9. The method of claim 1, wherein the function uses a regressed signed distance function with a neural network.

10. The method of claim 8, wherein the neural network is a fully connected multi-layer perceptron (MLP).

11. The method of claim 1, wherein the kinematic descriptor is computed based on kinematic poses of the deformable object.

12. An artificial-reality device for artificial-reality environments, the artificial-reality device comprising:
one or more processors;
memory that stores one or more programs configured for execution by the one or more processors, and the one or more programs comprising instructions for:
computing a kinematic descriptor for a deformable object based on a lower dimensional description;
computing a posed signed distance field parameterized by the kinematic descriptor using a function that regresses the field; and
performing contact simulation based on the posed signed distance field for the deformable object.

13. The artificial-reality device of claim 12, wherein computing the kinematic descriptor comprises modeling (i) kinetic energy density and (ii) Helmholtz free energy density of a material, of the deformable object.

14. The artificial-reality device of claim 12, wherein the lower dimensional description is obtained using a model reduction technique.

15. The artificial-reality device of claim 12, wherein the function uses a neural network.

16. The artificial-reality device of claim 12, wherein the function uses a regressed signed distance function with a neural network.

17. The artificial-reality device of claim 15, wherein the neural network is a fully connected multi-layer perceptron (MLP).

18. The artificial-reality device of claim 12, wherein the kinematic descriptor is computed based on kinematic poses of the deformable object.

19. A non-transitory computer-readable storage medium storing one or more programs configured for execution by an artificial-reality device having one or more processors, the one or more programs including instructions, which when executed by the one or more processors, cause the artificial-reality device to:
compute a kinematic descriptor for a deformable object based on a lower dimensional description;
compute a posed signed distance field parameterized by the kinematic descriptor using a function that regresses the field; and
perform contact simulation based on the posed signed distance field for the deformable object.

20. The non-transitory computer-readable storage medium of claim 19, wherein computing the kinematic descriptor comprises modeling (i) kinetic energy density and (ii) Helmholtz free energy density of a material, of the deformable object.
